(19) United States
(12) Patent Application Publication
(10) Pub. No.: US 2006/0057738 A1
(43) Pub. Date: Mar. 16, 2006

(54) Device, method, system and kit, for collecting components from a biological sample

(76) Inventor: Gerald E. Hall JR., Morrisville, PA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/943,431

(22) Filed: Sep. 16, 2004

(51) Int. Cl. G01N 1/10

(52) U.S. Cl. 436/177

(57) ABSTRACT

This invention relates to devices, systems, methods, and kits for collecting subcellular components from a biological sample. In one aspect, invention pertains to the isolation of total cellular RNA from a biological material, such as plant tissue.

### BACKGROUND

Many molecular biological techniques, such as the analysis of gene expression, cloning, restriction analysis, and sequencing, require the extraction and purification of subcellular components (e.g., DNA, RNA, proteins, organelles, nuclei, and the like). Conventional isolation procedures have significant drawbacks. Current purification methods often involve tedious multi-step processes. For example, tissues or cells must be lysed and homogenized, subcellular components extracted, and contaminants removed as the desired fractions are isolated. Each of these processes typically involves transfer from at least one tube or container to another. In addition to the time required for multiple extraction steps, sample loss may lead to relatively low yields of desired subcellular components.

Additional drawbacks in the isolation of nucleic acids include the fact that many of the current methods include steps of organic extraction which involve the use of toxic chemicals such as phenol (a known carcinogen), volatile reagents such as chloroform (which is highly volatile, toxic and flammable) and are difficult to perform in an automated or high throughput fashion. Further, use of organic solvent extraction methods results in organic wastes that must be disposed of in a regulated and environmentally conscientious manner.

Silica-based systems and methods, relying on SiO₂ compounds and related hydrated oxides, have been developed for use in isolating nucleic acids, since these will bind to silicon-containing materials such as glass slurries and diatomaceous earth. In general, the basic sequence of steps used in silica-based isolation processes consists of: disruption of the biological material in the presence of a lysis buffer; formation of a complex of nucleic acid(s) and a “silica-based matrix”; removal of the lysis buffer mixture from the resulting complex and washing of the complex; and elution of the target nucleic acid from the complex. With certain complex biological samples, purity and recovery of intact RNA can be poor, especially when processing samples from a small number of cells, or when isolating RNA from certain mammalian tissues, such as the pancreas, the spleen, or lung tissues. Further, the required silicate material is often not readily commercially available in the appropriate form, and often must be prepared on-site which adds additional time and effort to an isolation procedure.

In RNA isolation techniques, steps to remove genomic DNA contaminants must be included. Some commercially available RNA isolation kits provide a protocol for selective enzymatic removal of contaminating gDNA with Deoxyribonuclease I (DNase I). Treatment with DNase I occasionally results in a reduction of RNA yield and degradation of RNA by ribonucleases (RNases) that can contaminate commercially produced DNase I. DNase I treatment adds hands-on time, extends the length of time required for the process, and requires the addition of metal ions which can interfere with downstream processes.

In addition to the general difficulties described above, particular difficulties can be encountered in the application of molecular techniques to plant and yeast cells, and to bacteria, some of which have rigid cell walls.

Sample harvesting, preparation, and homogenization create time consuming steps in isolation of biological components. Currently, typical methods of homogenization and cell lysis include: grinding in a mortar and pestle with liquid nitrogen, mechanical disruption with a tissue homogenizer, such as a Polytron® or Omniprobe® homogenizer, manual homogenization (e.g., with a Dounce homogenizer), and shaking the sample in a container with metal balls. Mini samples can be processed with small pestles fitting into microcentrifuge tubes. For some samples, ultrasonic disruption is possible.

The QIAshredder™ unit (available from Qiagen, Inc., Valencia, Calif.) consists of a spin-column which is reported to shred tissue during centrifugation. Generally, cell lysates are transferred into the unit by pipetting or decanting from another container and the unit is centrifuged to obtain a homogenized lysate. The clarified lysates, which contain a pellet of cell debris, must then be transferred into another sample tube prior to addition of alcohol. This mixture is then transferred to another spin column, such as an RNeasy mini column, for RNA purification.

In summary, most conventional methods for isolating biological molecules are time-consuming, hazardous, and are not amenable to high throughput processing.

### SUMMARY

The invention pertains to devices and methods and kits for isolating subcellular components, e.g., nucleic acids, such as DNA or RNA, proteins, carbohydrates, lipids, subcellular fractions (e.g., mitochondria, nuclei, membranes, etc), and the like. The invention is particularly useful in high throughput assays.

In one aspect, the invention provides a device in which steps of harvesting a sample, cell disruption, and collection of subcellular components may be performed in a single device, eliminating the need to transfer sample to another device or container between one or more of the harvesting, cell disruption and collection steps. In certain aspects, the device provides a solution-contacting module for bringing a sample in contact with a solution to facilitate further processing steps. Additionally, in certain other aspects, devices according to the invention include material for reducing undesired subcellular components in a sample. For example, devices adapted for protein collection may include means for removing nucleic acids. Devices adapted for nucleic acid collection may include means for removing proteins. More particularly, devices for collecting genomic DNA (“gDNA”) may include means for removing RNA, while devices adapted for collecting RNA may include means for removing gDNA. The device may include additional elements for isolating subcellular components (e.g., such as binding matrices to which the components may bind and be selectively eluted from) or collected subcellular components may be removed from the device and subjected to further purification steps.

In one embodiment, a device according to the invention is used to harvest sample from a sample source, bringing sample into contact with a solution as it is harvested. In another aspect, while the sample is brought into proximity with a solution module during harvesting, the sample is isolated from solution until further processing steps may occur, for example, the solution barrier may comprise a solution that remains separated from a harvested sample (e.g., via a removable physical or chemical barrier) until a further processing steps may occur. In a further aspect, the solution comprises an agent for chemical lysis (e.g., a detergent, chaotropic salt, enzyme, and combinations thereof).

In another embodiment, the invention provides devices and methods for performing tissue harvest, homogenization and removal of undesired contaminants (“filtration”) from a sample without the need to transfer sample from one device or container to another between harvest, homogenization, and filtration steps. In another aspect, the invention eliminates sample-to-sample contamination since devices according to certain aspects of the invention are self-contained and disposable.

A device according to one aspect of the invention is particularly suited for isolation of nucleic acids from a plant sample. In one aspect, tissue harvest, homogenization and filtration are all combined into a single, rapid step using the device. The device may be used to obtain a sample, such as a core or disc of leaf, from a plant without substantially damaging the plant. For example, a leaf being sampled need not be removed from a plant. Thus, in certain aspects, the device is particularly useful for field applications. In one aspect, the device is adapted for DNA collection. Such a device may include RNA removal components. In another aspect, the device is adapted for RNA collection (e.g., such as total RNA (“tcRNA”) collection) and optionally includes gDNA removal components. In a further aspect, the device is adapted for protein collection and optionally includes nucleic acid removal components.

In one embodiment, the invention provides a device comprising two or more modules selected from the group consisting of: a harvesting module, a solution module for holding solution proximal to a tissue until homogenization occurs, a homogenization module for homogenizing a biological sample, a filtration module for removing undesired contaminants from a biological sample, and a collection module for collecting selected subcellular components (e.g., such as an RNA-containing elute) from a sample. The device may be configured so that the harvesting module is in proximity to the solution module, which may be operatively isolated from the harvesting module (e.g., prevented from releasing solution) until a desired time (e.g., such as until processing steps may occur).

A module of the device may perform more than one function. For example, in certain aspects, the lysis function and homogenization function of the device are combined in a single module—a “lysis/homogenization module.” In another aspect, the solution module additionally comprises a lysis medium for lysing a sample. In a further aspect, a lysis module may be provided which comprises a lysis medium comprising one or more chemical lysis agents that may be used to contact a sample that has been harvested, solution-contacted, and/or homogenized.

In one aspect, the device comprises a harvesting module for obtaining a sample from a sample source; a solution module for contacting a sample with solution, a homogenization module for homogenizing a sample; a filtration module for removing undesired contaminants from a sample; and a collection module for collecting desired subcellular components from a sample. Either or both the homogenization module and the solution module may comprise lysis buffer and/or a separate lysis module may be provided.

In another aspect, the device comprises a housing with walls defining a lumen, an open end and a closed bottom end. In one aspect, the lumen contains at least two of a homogenization module for homogenizing a sample, a filtration module for removing non-desired contaminants from a sample, and a collection module for collecting desired subcellular components from a sample. In another aspect, the lumen comprises a lysis/homogenization module for homogenizing a sample, a filtration module for removing undesired contaminants from a sample, and a collection module for collecting desired subcellular components from a sample. In a further aspect, the lumen comprises a lysis module, a homogenization module for homogenizing a sample, a filtration module for removing undesired contaminants from a sample, and a collection module for collecting desired subcellular components from a sample. In one aspect, the device is adapted for protein collection. In another aspect, the device is adapted for DNA collection. In a further aspect, the device is adapted for RNA collection. In still other aspects, the device may be adapted for lipid or carbohydrate collection. In certain aspects, combinations of different biomolecules may be collected in the collection module (e.g., DNA and RNA; nucleic acids and protein, etc.)

In a further aspect, the device further comprises a cap for covering the open end, the cap comprising edges for coring a sample from a sample source placed between the edges and the open end. The type of material used to fabricate the edges can be selected to suit a particular sample type being harvested. For example, in certain cases the edges are plastic or another polymeric material, while in other cases the edges may comprise a metal. In one aspect, the harvesting module is a removable unit of the device and tissue may be harvested and held in proximity to the coring edges of the module (e.g., under refrigeration) until further sample processing. In certain embodiments, a plurality of devices may be provided inserted into a container for receiving the plurality of devices, the container comprising a plurality of device-openings or the plurality of devices may be molded as a single unit. The removed harvesting modules can be inserted into the plurality of devices to facilitate high throughput processing, such as parallel cell disruption or homogenization of multiple samples at a time. The edges of the harvesting module may be angled at an angle which is not perpendicular to the longitudinal axis of the lumen of the device housing or curved to facilitate retention of the sample within the harvesting module. In some aspects, the harvesting module is marked with an identifier which may be used to identify a sample being processed. The identifier may be a written identifier, a bar code, a radiofrequency tag or a remotely programmable memory.

In certain aspects, the solution module is stably associated with or affixed to (e.g., using an adhesive) the cap, such that a sample is in sufficient proximity to the solution module to be contacted by solution in the solution module when the sample is placed between the cap and the open end. As used herein, “stably associated” means that the medium comprising solution remains in proximity to the sample when the cap is used to cover the open end. However, in one aspect, solution in the solution module is controllably isolated from a sample being harvested. For example, in some embodiments, it is desired to harvest a sample and expose the harvested sample to solution and further processing steps (e.g., homogenization, filtration, collection) until a later time. This may be done in a number of ways, such as by providing a removable barrier between a solution in the solution module and the harvested sample, by maintaining solution in the solution medium inaccessible form until desired process steps can occur (e.g., by providing a frozen solution which can be subsequently melted to liquid form), or by adding solution to the solution medium only when additional processing steps are to occur or at an otherwise desirable time.

In some aspects, the solution module comprises a lysis medium comprising a lysis solution, such that a sample is in sufficient proximity to the lysis medium to be contacted by lysis solution in the lysis medium when the sample is placed between the cap and the open end or at desired times as discussed above.

In still another aspect, the homogenization module is in sufficient proximity to the open end of the housing that closing the open end brings the sample into contact with the homogenization module, thereby homogenizing the sample. Disrupted cells may be subsequently exposed to solution from a solution module, which may be on either, or both sides of the homogenization module.

In a further aspect, the device comprises a column insertable into the lumen of the housing. The column comprises one or more of: a solution-contacting module, a homogenization module for homogenizing a sample, a lysis/homogenization module, a filtration module for removing undesired contaminants from a sample, and a collection module for collecting desired subcellular components from a sample. In certain aspects, a plurality of device housings is provided in a holder or container or rack and a plurality of columns may be inserted into the lumen of each of the housings. In one aspect, the plurality of device housings is provided as a single unit (e.g., molded as a single unit from a plastic or other suitable material) comprising a plurality of lumens for receiving a plurality of columns.

In one embodiment, the invention provides a method of isolating subcellular components from a biological sample comprising performing two or more of the following steps of: harvesting a sample from a sample source, contacting the sample with a solution, homogenizing the sample to produce a homogenized sample, removing undesired contaminants from a homogenized sample to obtain a treated sample, and collecting desired subcellular components from the treated sample, without transferring sample from one container to another. The method may be performed using any of the devices discussed above. In some aspects, the method additionally includes a chemical lysis step, which may be performed prior to, at the same time as, and/or after homogenization. As discussed above, since it is sometimes desirable to harvest a sample without immediately proceeding to processing steps, in some embodiments, the step of contacting the harvested sample with solution may be delayed until further processing steps may be performed (e.g., such as homogenization, filtration, collection, etc.).

In one aspect, the method comprises contacting a sample source (such as the leaf of a plant) with edges of the harvesting module of the device and bringing a sample (a core or disc of leaf tissue) obtained from the sample source in contact with a solution module to obtain a solution-contacted sample from which subcellular components (e.g., proteins, DNA, RNA, lipids, carbohydrates, organelles) may be isolated. In another aspect, solution-contacted sample is homogenized to produce a homogenized sample and undesired components are removed from the homogenized sample, producing a filtered sample. The desired subcellular components may then be collected from the filtered sample. An additional step of binding particular subcellular components from the filtered sample to a binding material and eluting the subcellular component from the binding material also may be included. In a further aspect, a sample is lysed as it is homogenized in a lysis/homogenization module and desired subcellular components are isolated from the lysed, homogenized sample. The order of the one or more steps may be varied and/or repeated. For example, a sample may be contacted with solution and a lysis medium simultaneously, or contacted with a lysis solution and homogenized simultaneously. A sample (which may or may not have been chemically lysed) may be subjected to a homogenization step and then lysed. Other obvious permutations may be contemplated and are encompassed within the scope of the invention.

In one aspect, the device is used to collect protein from a biological sample. In another aspect, the device is used to collect DNA from a biological sample. In a further aspect, the device is used to collect RNA (e.g., tcRNA) from a biological sample. In some aspects, lipids or carbohydrates are collected. In one aspect, the biological sample comprises plant cells, and the device is used to isolate nucleic acids, such as DNA or tcRNA.

Using devices according to certain aspects of the invention, harvesting, contacting with solution, lysis, homogenization, and filtration may be performed without transferring sample out of the device to another device or container. When the device includes a column, the column may be removed from the lumen of the housing, e.g., to add solutions or to perform one or more washes of module(s) in the column and reinserted into the lumen of the housing of the device, e.g., for elution of RNA from the column. Further processing steps (further isolation steps, precipitation steps, etc) may be performed after collection of a desired subcellular fraction. Such steps may be performed after removing a solution comprising the desired subcellular fraction from the device. However, in one aspect, a collected sample is of suitable purity for performing an assay, e.g., an enzyme-based assay such as PCR, a hybridization assay (such as an array-based assay), an immunoassay, and the like.

In one embodiment, the invention further provides a kit comprising one or more of the devices described above or equivalents thereof and one or more reagents. In one aspect, a reagent is selected from the group consisting of: an organic solvent, a label, a solution, such as a sample buffer (e.g., PBS), a lysis solution, one or more chaotropic salts a wash buffer, DNAse, RNAse, RT-PCR reagents, RNAse-free water, RNase inhibitors (e.g., DEPC, a vanadyl compound, etc), protein stabilizing reagents, a chemical array and combinations thereof. In another embodiment, the invention provides a kit comprising a plurality of harvesting modules.

### BRIEF DESCRIPTION OF THE FIGURES

The objects and features of the invention can be better understood with reference to the following detailed description and accompanying drawings. The Figures shown herein are not necessarily drawn to scale, with some components and features being exaggerated for clarity.

FIG. 1 shows a device for collecting subcellular components according to one aspect of the invention.

FIGS. 2A-2C illustrate a method for collecting subcellular components according to one aspect of the invention.

### DETAILED DESCRIPTION

The invention pertains to devices and methods and kits for isolating subcellular components from a sample, such as proteins, nucleic acids (e.g., DNA and/or RNA), lipids, carbohydrates, organelles, membranes and the like. In one aspect, the invention is directed toward the isolation of total cellular RNA (“tcRNA”). In another aspect, the invention provides a device that combines harvesting, cell disruption, and collection functions without the need for sample transfer between steps and methods for using the same. In a further aspect, the device provides a solution-contacting function for facilitating one or more processing steps. Additionally, the invention relates to devices and methods for reducing undesirable sample components in a biological sample without introducing harmful contaminants, and without significantly increasing the time required for the overall procedure being performed on a sample.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates that may need to be independently confirmed.

It must be noted that as used herein and in the appended claims, the singular forms “a”, “an”, and “the” include plural referents unless the context clearly dictates otherwise.

“May” refers to optionally.

When two or more items (for example, elements or processes) are referenced by an alternative “or”, this indicates that either could be present separately or any combination of them could be present together except where the presence of one necessarily excludes the other or others.

The following definitions are provided for specific terms, which are used in the following written description.

The term “binding” refers to two objects associating with each other to produce a stable composite structure under the conditions being evaluated (e.g., such as conditions suitable for RNA isolation). Such a stable composite structure may be referred to as a “binding complex”.

As used herein, the term “RNA” or “oligoribonucleotides” refers to a molecule having one or more ribonucleotides. The RNA can be single, double or multiple-stranded (e.g., comprise both single-stranded and double-stranded portions) and may comprise modified or unmodified nucleotides or non-nucleotides or various mixtures and combinations thereof.

As used herein, the term “DNA” or “deoxyribonucleotides” refers to a molecule comprising one or more deoxyribonucleotides. The DNA can be single, double or multiple-stranded (e.g., comprise both single-stranded and double-stranded portions) and may comprise modified or unmodified nucleotides or non-nucleotides or various mixtures and combinations thereof.

As used herein “complementary sequence” refers to a nucleic acid sequence that can form hydrogen bond(s) with another nucleic acid sequence by either traditional Watson-Crick or other non-traditional types (for example, Hoogsteen type) of base-paired interactions.

In certain embodiments, two complementary nucleic acids may be referred to as “specifically hybridizing” to one another. The terms “specifically hybridizing,” “hybridizing specifically to” and “specific hybridization” and “selectively hybridize to,” are used interchangeably and refer to the binding, duplexing, complexing or hybridizing of a nucleic acid molecule preferentially to a particular nucleotide sequence under stringent conditions. “Hybridizing” and “binding”, with respect to polynucleotides, are used interchangeably.

The term “reference” is used to refer to a known value or set of known values against which an observed value may be compared.

It will also be appreciated that throughout the present application, that words such as “cover”, “base” “front”, “back”, “top”, “upper”, and “lower” are used in a relative sense only.

As used herein, the term “contacting” means to bring or put together. As such, a first item is contacted with a second item when the two items are brought or put together, e.g., by touching them to each other.

As used herein, the term “solid phase” or “solid substrate” includes rigid and flexible solids. Examples of solid substrates include, but are not limited to, gels, fibers, microspheres, spheres, cubes, particles of other shapes, channels, microchannels, capillaries, walls of containers, membranes and filters.

As used herein, an “subcellular component-binding material”, stably binds a subcellular component (e.g., such as DNA, RNA, protein, lipid or carbohydrate). By “stably binds” it is meant that under defined binding conditions the equilibrium substantially favors binding over release of the subcellular component, and if the solid substrate containing a selected bound subcellular component is washed with buffer lacking the component under these defined binding conditions, substantially all the component remains bound. In particular embodiments the binding is reversible. As used herein, the term “reversible” means that under defined elution conditions the bound subcellular component is predominantly released from the subcellular component-binding material and can be recovered (e.g., in solution). In particular embodiments, at least 80%, at least 90%, or at least 95% of the bound subcellular component is released under the defined elution conditions.

As used herein, a “subcellular component” refers to any molecule or aggregate of molecules that may be found within a cell, including, but not limited to proteins, polypeptides, peptides (as used herein, the terms are used interchangeably), nucleic acids (such as DNA, RNA, DNA-RNA complexes, and the like), lipds, carbohydrates, organelles (e.g., mitochondria, golgi complexes), nucleic, membrane fractions, and the like. The term “subcellular component” does not imply that the components are necessarily from a tissue. For example, mixtures of natural and/or synthetic molecules may be combined to provide a sample comprising subcellular components.

“Washing conditions” include conditions under which unbound or undesired components are removed from a module of a device described below.

The term “assessing” “inspecting” and “evaluating” are used interchangeably to refer to any form of measurement, and includes determining if an element is present or not. The terms “determining,” “measuring,” “assessing,” and “assaying” are used interchangeably and include both quantitative and qualitative determinations. Assessing may be relative or absolute. “Assessing the presence of” includes determining the amount of something present, as well as determining whether it is present or absent.

A chemical “array”, unless a contrary intention appears, includes any one, two or three-dimensional arrangement of addressable regions bearing a particular chemical moiety or moieties (for example, biopolymers such as polynucleotide sequences) associated with that region. For example, each region may extend into a third dimension in the case where the substrate is porous while not having any substantial third dimension measurement (thickness) in the case where the substrate is non-porous. An array is “addressable” in that it has multiple regions (sometimes referenced as “features” or “spots” of the array) of different moieties (for example, different polynucleotide sequences) such that a region at a particular predetermined location (an “address”) on the array will detect a particular target or class of targets (although a feature may incidentally detect non-targets of that feature). Such a region may be referred to as a “feature region”. The target for which each feature is specific is, in representative embodiments, known. An array feature is generally homogenous in composition and concentration and the features may be separated by intervening spaces (although arrays without such separation can be fabricated).

Additional terms relating to arrays and the hybridization of nucleic acids to such arrays may be found, for example, in U.S. Pat. No. 6,399,394.

The present invention pertains to devices and methods used for collecting and/or isolating subcellular components. In one aspect, the device is used to collect proteins. In another aspect, the device is used to collect nucleic acids such as DNA or RNA. In a further aspect, the device is used to collect RNA molecules, such as tcRNA. Devices according to the invention generally comprise a modular structure for performing a plurality of functions in a single device without the need to transfer sample from one container to another. Accordingly, methods of using the devices are particularly suited for high throughput analyses. As used herein, the term “modular structure” or “modules” refers to elements or units in the device that may or may not be removable from the device, which perform discrete functions. In one aspect, one or more modules are physically distinct from other modules (e.g., the modules do not occupy the same space). However, in certain aspects, modules according to the invention may perform more than one function. In one aspect, a device comprises at least two modules, each module performing at least one different function from the other module.

In one embodiment, the device comprises a housing, comprising one or more modules for contacting a sample with solution (“solution module”) and homogenizing sample cells. In one aspect, the device comprises a module for chemically lysing cells. For example, in one aspect, the device comprises a solution module, a lysis module, and homogenization module. In another aspect, a lysis medium is provided in the solution module and/or the homogenization module. The configuration of the device eliminates the need for sample transfer between lysis and homogenization steps.

In a further aspect, the housing comprises an open end and comprises walls defining a lumen into which may fit one or more modules of the device. In another aspect, the device comprises a closed bottom end. The modules of the device may be removable from the housing or an integral part of the housing or some combination thereof. The shape and dimensions of the housing may vary. However, in one embodiment, the housing is shaped like a tube or column. In another aspect, the housing is shaped like a tube and one or more of the modules are provided in the form of a column which fits into the tube. Individual modules may be separated from each other one at a time, e.g., by unscrewing or snapping apart. Likewise, the housing may be made from a variety of materials, including but not limiting to, a polymeric material such as plastic, polycarbonate, polyethylene, PTFE, polypropylene, polystyrene and the like.

In one aspect, the device further comprises a cap for covering the open end. The cap may be removable from the device or may be affixed to the device at least one end. In one aspect, the cap may be snapped onto the open end. In another aspect, the cap may be twisted or screwed onto the open end. In a further aspect, the cap is removable from the device housing.

In one embodiment, a device according to the invention comprises a harvesting module for harvesting a portion of tissue or groups of cells from a sample source. Sample sources include, but are not limited to, animal, plants, fungi (e.g., such as yeast), bacteria, and portions thereof. In one aspect, the animal can be a mammal, and in a further aspect, the mammal can be a human. Sample sources may additionally include virally infected cells, as well as transgenic animals and plants or otherwise genetically modified animals and plants.

The harvesting module generally comprises a surface for removing a sample of tissue or cells from sample source (typically, a larger piece of tissue or group of cells). In one aspect, the harvesting module comprises edges for coring a sample. The edges are of sufficient hardness and rigidity that the application of force on the edges as it is contacted with the sample source, or after it is contacted with the sample source, is sufficient to remove a sample from the sample source for further processing in the device. As used herein, the term “coring” or “core” does not imply that sample removed from sample source comprises a circular shape or that the edges of the harvesting module defines a circular shape. As used herein, the term “core” may also refer to a “disc” or “punch” of tissue or cells. A core may comprise any type of shape (square, polygonal, elliptical, circular, etc.) and may be irregularly shaped. Devices according to the invention are particularly suited for obtaining cores of plant tissue (e.g., such as a sample of leaf tissue) without killing the plant, or even the leaf, from which the core is obtained. However, a sample source also may comprise frozen, lyophilized, desiccated, or fixed source tissue/cells, or tissue/cells otherwise removed from an environment in which they are naturally found or cultivated. The edges of the harvesting module comprise a material suitable for coring a desired material; for example, the edges may comprise a plastic or polymeric material or a metal.

In one aspect of the invention, the harvesting module eliminates the need to weigh tissue samples to insure uniformity in the RNA isolation process as the edges of the harvesting module insure that a consistent core sample is obtained from assay to assay, using the same device or multiple devices fabricated according to the same specifications. The harvesting module can produce sample cores having a consistent surface area. In one aspect, the dimensions of the edges of the harvesting module are sufficient to core a sample of about 5 mg or greater in weight.

In certain aspects, the harvesting module is removable from the remainder of the device and a harvesting module may be used remotely from the device to harvest a sample (e.g., in the field). The harvesting module may be stored under suitable conditions (e.g., refrigerated or frozen or otherwise maintained under conditions that minimize degradation of desired subcellular components) and placed in proximity to the device when further processing of the harvested sample is desired. A plurality of harvesting modules may be used to harvest a plurality of samples and placed in a plurality of devices for parallel and/or sequential processing of multiple samples.

In one embodiment, the device comprises a cap and the edges of the cap and/or the open end of the housing define the edges of the harvesting module. Placing a sample source between the cap and the edges defining the open end of the housing, and applying a force on the sample (e.g., by pressing down on the cap or snapping or twisting the cap to cover the open end) is sufficient to eject a core of sample into the device.

In one aspect, the device comprises a solution module which comprises a solution medium. As used herein, a “solution medium” refers to a solid phase for retaining a solution until contact with a sample is made. In one aspect, the solid phase comprises an absorbent material such as a filter or sponge. In another aspect, the solid phase comprises removable or penetrable barrier, which may be chemical or physical or a condition of the solution itself, which prevents solution from contacting sample until the barrier is penetrated or removed.

In one aspect, the solution module is within sufficient proximity of the harvesting module that removal of the sample from its source (e.g., removal of a leaf sample from a leaf) by the harvesting module results in contact between the sample and a sample contacting solution (e.g., such as PBS, 1 mM Tris-HCL, pH 7, and the like). Although the device may core tissue samples from a sample source; populations of cells which are not aggregated in the form of a tissue also may be processed using the device, e.g., by placing the cells directly in proximity to the sample contacting solution. The solution module may comprise a solution medium comprising any suitable material that is capable of retaining a sufficient amount of solution for contacting sample cells provided by the harvesting module. In one aspect, the solution medium is an absorbent material. For example, the solution medium may comprise a filter (such as available from Whatman) or a sponge material. In one aspect, the solution medium is a hydrophilic inert material comprising a porous structure. Suitable materials include, but are not limited to plastics, glass, and cellulose and other materials know in the art, wetted with sufficient amount of solution to wet sample cells provided by the harvesting module. In one aspect, about 10 μl of solution per milligram of sample being harvested is used. In another aspect, about 10-100 μl is used. In a further aspect, about 20-40 μl per milligram of sample is used.

However, in certain aspects, the solution medium is kept operatively isolated from the harvesting module, such that harvesting does not immediately result in contacting with solution. This application may be particularly desirable in the field where it may be practical to collect samples in a plurality of devices (e.g., such as in the field) and process samples at a later time. The solution may be kept separate from the harvesting module by providing a removable physical barrier, e.g., such as by covering the solution medium with a removable seal (for example, a foil that may be pealed away) or a cover or cap that may be removed. Alternatively, or additionally, the solution in the solution medium may be chemically or physically inaccessible to sample (e.g., retained in a gel or wax layer or frozen) and exposed to sample at a desired time (e.g., by melting the gel, wax layer, or frozen solution). In still another aspect, the solution may be added to the solution medium just prior to performing processing steps. Other obvious methods for keeping the solution medium may be possible and are encompassed within the scope of the invention.

In one aspect, a lysis module is within sufficient proximity of the harvesting module that removal of the sample from its source (e.g., removal of a leaf sample from a leaf) by the harvesting module results in contact between the sample and a lysis medium. Although the device may core tissue samples from a sample source; populations of cells which are not aggregated in the form of a tissue also may be processed using the device, e.g., by placing the cells directly in proximity to the lysis medium. In some aspects, the lysis function of the device is combined with the sample solution contacting function, e.g., the solution medium may comprise a lysis solution. As with the solution medium, the lysis medium may be kept operatively isolated from the harvesting module until a desired time.

Suitable lysis solutions are known in the art. However, in one aspect, the lysis solution comprises a sodium hydroxide, a chaotropic salt, and/or additives to protect RNA in the sample from degradation or reduced yield. Suitable salts include but are not limited to urea, formaldehyde, ammonium isothiocyanate, guanidinium isothiocyanate, guanidinium hydrochloride, formamide, dimethylsulfoxide, ethylene glycol, tetrafluoroacetate, diamineimine, ketoaminimine, hydroxyamineimine, aminiguanidine hydrochloride, aminoguanidine hemisulfate, hydroxylaminoguanidine hydrochloride, sodium iodide and mixtures thereof. In another aspect, the lysis solution comprises one or more enzymes to facilitate disruption of cells in a sample. Suitable enzymes include, but are not limited to, a protease, lysozyme, zymolase, cellulase, and the like. In still other aspects, a lysis solution may include one or more agents for stabilizing nucleic acids, such as, but not limited to cationic compounds, detergents (e.g., SDS, Brij, Triton-X-100, Tween 20, DOC, and the like), chaotropic salts, ribonuclease inhibitors, chelating agents, DEPC, vanadyl compounds, and mixtures thereof. Examples of ribonuclease inhibitors can be found in Farrell R. E. (ed.) (RNA Methodologies: A Laboratory Guide for Isolation and Characterization, Academic Press, 1993) and Jones, P. et al. (In: RNA Isolation and Analysis, Bios Scientific Publishers, Oxford, 1994). In one aspect, RNAlater® (Ambion Inc., Austin, Tex., U.S. Pat. No. 6,204,375) is used as an RNAse inhibitor.

The medium for holding the solution (e.g., a filter or sponge) (optionally, a lysis solution) may be contacted with the solution (e.g., by pipetting) or the device may be provided with a medium already wetted with solution. In such an embodiment, the medium may be prevented from excessive drying (i.e., drying which prevents sufficient wetting of a sample for further processing steps) by covering the medium with a removable cover such that the device may be stored or shipped without substantial evaporation of the solution. For example, a medium such as a filter or sponge may comprise a cover (such as a foil cover), which may be peeled away prior to use. In one aspect, the filter or sponge is impregnated with agents for facilitating lysis and is otherwise dry. The user then adds a suitable amount of water or buffer to generate a lysis solution for contacting with a harvested sample.

In one aspect, the solution module (optionally, a lysis module) is affixed to or otherwise stably associated with a cap that fits onto the open end of the housing. In another aspect, covering or sealing the open end of the device with the cap while a sample source, such as a tissue (e.g., a leaf), is placed between the edges of the cap and the open end, causes a sample core be brought into sufficient proximity with the medium of the solution module to sufficiently wet the sample for further processing steps (or to lyse the sample, when the solution module functions as a lysis module). As discussed above, in certain embodiments, however, the solution medium in the cap may be kept isolated from tissue placed in contact with the harvesting module until a desired time.

In another embodiment, the device comprises two or more of: a solution module, a lysis module, a harvesting module, and a homogenization module. In one aspect, a homogenization module according to the invention produces a homogenized sample. A “homogenized sample,” as used herein, is one in which greater than about 25%, greater than about 50%, greater than about 70%, greater than about 80%, greater than about 90% or 100% of cells in the sample do not comprise intact cell membranes when viewed under a microscope and/or which releases intracellular components into a solution. In one aspect, a homogenized sample is one in which greater than about 25%, greater than about 50%, greater than about 70%, greater than about 80%, greater than about 90% or about 100% of subcellular components (e.g., such as RNA) in a cell is released from the cell (e.g., into a suitable solution) within the device.

As used herein, the term “homogenize” refers to disrupting a cell by a non-chemical means (i.e., the lysis module is not considered to “homogenize” as the term is used herein). In one aspect, the non-chemical means is a physical or mechanical means. For example, in one aspect, the homogenization module provides a structure that tears, grinds, shreds, or otherwise breaks apart tissues and/or cells. In general, the homogenization module does not operate by changes in temperature (e.g., by freeze-thawing or heating) or by providing ultrasound, although such means may be used to enhance the functionality of the homogenization module, e.g., the housing may comprise heating or cooling elements or may be exposed to an ultrasound source.

In another aspect, the homogenization module comprises a stationary element (e.g., the homogenization module does not comprise a movable part such as a rotor, blade, pestle, motorized element, etc.). In a further aspect, the homogenization module does not comprise a solution phase, e.g., such as a plurality of glass beads in solution.

In one aspect, the housing comprises a frit for holding the homogenization module within the housing. However, in another aspect, the housing receives a column, which comprises the homogenization module in addition to one or more other modules of the device. In one aspect, the homogenization module comprises a homogenization material, including but not limited to a course or particulate or fibrous or porous material, e.g., such as a glass fiber filter material or borosilicate material, a solid phase comprising a plurality of beads (e.g., such as glass beads), a wire mesh material, a screen material, a woven or non-woven material, a filter, a gel, fleeces, fibers, pressed paper, cellulose, a polymeric material, a plastic material, polyethylene (e.g., sintered polyethylene), polypropylene, polytetrafluoroethylene, combinations and composites thereof, and the like. The homogenization material may comprise a plurality of material layers. Generally, homogenization occurs under conditions in which desired subcellular components released from sample cells does not bind to the homogenization material. For example, in one aspect, homogenization occurs under conditions in which RNA does not bind to the homogenization material.

In one aspect, devices are provided comprising homogenization material comprising particles or fibers having sizes suitable to homogenize a sample being evaluated, e.g., comprising smaller sized fibers or particles for bacteria and yeast and larger sizes for plant and animal tissue. In one aspect, the homogenization material comprises a non-uniform particle or fiber size. In another aspect, the homogenization material comprises a plurality of layers, each layer having a different particle or fiber size. In a further aspect, the homogenization material comprises a plurality of pores defined by an aggregation of fibers or other course material (e.g., such as glass beads, sand, etc) that may be uniform or non-uniform.

Contact of a sample with the homogenization material in the presence of a force (e.g., such as centrifugal force) forces portions of the sample through the pores, and disrupts or homogenizes the cells within the sample. Pore sizes may range from about 5 μm to about 10 mm, from about 5 μm to about 5 mm, or from about 5 μm to about 2.5 mm, from about 5 μm to about 500 μm, from 5 μm to about 50 μm. In one aspect, the homogenization material comprises a plurality of layers comprising on average, increasingly smaller pore sizes, e.g., from 50-500 μm to 5-50 μm. In another aspect, the flow pass geometry of the homogenization material is tortuous, allowing flow through of a solution comprising homogenized sample components, while retaining particles (e.g., cell walls, cellular debris, etc) ranging from about greater than about 0.2 μm, greater than about 0.5 μm, greater than about 1 μm, greater than 5 μm, greater than about 10 μm, greater than about 20 μm, or greater than about 50 μm. The homogenization material may comprise a plurality of layers, each layer having a different particle filtration size. In one aspect, the homogenization module comprises filter layers that retain increasingly smaller particles. The thickness of the homogenization material may vary. In one aspect, the thickness varies from about 50 μm to 20 mm.

In another aspect, the homogenization module is in sufficient proximity to the homogenization module that harvesting brings the sample into substantially immediate contact with the harvesting module. For example, in one aspect, when the device comprises a cap and housing comprising a open end and the harvesting module is defined by edges of a cap and/or open end of the device, the harvesting module is in sufficient proximity to the open end that placing the sample between the cap and open end and closing the cap forces sample cells against the homogenization module, disrupting cell membranes of the sample cells.

The homogenization module also may provide a physical barrier that enables an unhomogenized sample to remain in contact with a solution medium until it is at least partially wetted by the solution medium. A frit may be on one or both sides of the homogenization material of the homogenization module. In one aspect, a retainer ring (e.g., molded to a wall of the housing of the device) is on one side of the homogenization material (e.g., proximal to the lysis module), while a frit is on the other side. When the solution medium comprises a lysis solution, the homogenization module may provide a physical barrier that enables an unhomogenized sample to remain in contact with the lysis medium until it is at least partially lysed. Alternatively, or additionally, the homogenization module may comprise a lysis solution and chemical lysis may occur after or during homogenization.

In certain other aspects, the harvesting module brings the cells into contact with the homogenization module, disrupting the cells. The disrupted cells come into contact with a solution module comprising a solution on the distal side of the homogenization module (e.g., the side facing away from the harvesting module). Other permutations are possible. For example, a solution module may be on both sides of the harvesting module or the homogenization module itself may be impregnated with a solution (which may additionally, include one or more chemical lysis agents).

Released subcellular components passing through the homogenization module may pass directly to a collection module for further processing and isolation steps or for use in assays (e.g., such as immunoassays or PCR). In one aspect, proteins are collected in the collection module. In another aspect nucleic acids (e.g., DNA and/or RNA) are collected in the collection module. In still another aspect, lipids or carbohydrates are collected in the collection module. In a further aspect, organelles or other cell fractions (e.g., nuclei, membrane components, and the like) are collected in the collection module.

In one embodiment, the device comprises two or more of: a solution module, lysis module, a lysis/solution module, harvesting module, a homogenization module, a homogenization/lysis module and a module for removal of undesired subcellular components from a sample (“filtration module”). In another embodiment, the device comprises three or more of a solution module, lysis module, lysis/solution module, harvesting module, homogenization module, lysis/homogenization module and filtration module. In still another embodiment, the device comprises a solution module, lysis module, harvesting module, homogenization module and filtration module.

In one aspect, the filtration module removes undesired subcellular components from a homogenized sample. Undesired components will depend on the goals of the collection step. For example, when proteins are being collected, undesired components may include lipids, carbohydrates, nucleic acids, cell walls, and other cellular contaminants. In some cases, particular types of proteins may be considered contaminants while others are not. For example, the filtration module may comprise one or more antibodies for depleting the sample of specific types of protein while allowing others to pass through. Additionally, the filtration module may comprise anionic exchange groups or cationic exchange groups as appropriate for a particular type of sample collection. In certain aspects, the filtration module comprises carbohydrate-binding molecules for binding to carbohydrate-containing molecules. For example, the carbohydrate-binding molecules may comprise lectins. In other aspects, the filtration module may comprise macroporous beads, hydroxyapatite-coated materials, and the like for removing lipids from a sample. When DNA is being collected, undesired components may include one or more of: lipids, carbohydrates, RNA, cell walls and other cellular contaminants. However, in some cases, when the device is used to collect certain types of DNA (e.g., plasmid DNA, viral DNA, etc), genomic DNA also may be a contaminant. In cases where RNA is desired, contaminants may include one or more of: proteins, lipids, carbohydrates, DNA, cell walls, and other cellular contaminants. In certain cases, the undesired component comprises a molecule of a certain size class while the desired component may comprise a molecule of another size class. For example, the undesired component may comprise genomic DNA while the desired component may comprise plasmid DNA.

In one aspect, the module comprises a filter or column that retains undesired contaminants components in a sample homogenate or otherwise removes the components while desired subcellular components pass through. In another aspect, a plurality of different types of filters may be added or removed to devices as desired to remove particular combinations of subcellular components.

In one aspect, the module comprises a porous material. Suitable materials for fabricating the module include, but are not limited to, glass fibers or borosilicate fibers, anionic exchange resins, silica gels (which may be further treated using chaotropic salts), polymers (e.g., beads, filters, membranes, fibers) to which binding molecule (e.g., antibodies, lectins, anions, cations, hydrophobic molecules, hydrophilic molecules) may be associated. Generally, any material suitable for retaining cellular debris may serve as a component of the filtration module. In one aspect, the fiber material demonstrates particle retention in the range of about 0.1 μm to about 10 μm diameter equivalent.

The fibers can have a thickness ranging from about 50 μm to about 2,000 μm. For example, a typical fiber filter has a thickness of about 500 μm total thickness. The specific weight of a fiber filter typically ranges from about 75 g/m² up to about 300 g/m². Multiple fiber layers are envisaged to be within the scope of this invention. The fiber may, optionally, comprise a binder, e.g., for improving handling of the fiber or for modifying characteristics of a composite fiber (i.e., one which is not pure borosilicate). Examples of binders include, but are not limited to, polymers such as acrylic, acrylic-like, or plastic-like substances. Although it can vary, typically binders may represent about 5% by weight of the fiber filter. In one aspect, the filtration module comprises DNAse.

The pore size of the filter may be uniform or non-uniform. Where a plurality of filters are used, the pore size of each filter may be the same or different. In another aspect, suitable pore sizes may range from about 5 um to about 2 mm.

In a particular aspect of this invention, the filtration module column comprises at least one layer of fiber filter material along with a retainer ring that is disposed adjacent to a first surface of the fiber filter material that securely retains the layer(s) of fiber filter material so that they do not excessively swell when sample is added. In one aspect, a frit is provided which is disposed adjacent to a second surface of the fiber filter material. The frit may assist in providing support so that the materials of the filter fibers do not deform. In one aspect, the frit is composed of polyethylene of about 90 μm thick.

In one exemplary embodiment, the filtration module comprises Whatman GF/F Glass Fiber Filters (cat no. 1825-915) (available from Fisher Scientific, Atlanta, Ga.) or an equivalent material. Multiple layers (of the large sheets or disks supplied) may be punched, for example, with a 9/32″ hand punch (McMaster-Carr, Chicago, Ill.) and placed into a spin column (Orochem, Westmont, Ill.) fitted with a 90 μm polyethylene frit (Porex Corp., Fairburn, Ga.) on which the fibers may rest. The filter materials may be secured in the column with a retainer ring on top of the filter materials to prevent excessive swelling of the fibers or movement during centrifugation.

Filtration modules may comprise a variety of suitable materials and may be fibrous or non-fibrous. In one aspect, a suitable filtration material comprises a hydrophilic porous material. In another aspect, the filtration module comprises a material which is the same or similar to those described for the homogenization material but on average comprises a smaller pore size.

In still another aspect, the homogenization module is adjacent the filtration module. In a further aspect, the homogenization module is retained within the device by a retainer ring at one end and the filtration module at the other end, which itself is held in place by a retainer ring or frit (e.g., such as a polyethylene frit). In one aspect, the homogenization module is non-penetrable by a sample; however, homogenized sample may penetrate or be forced through the homogenization module and/or through the filtration module by centrifugation and/or through the application of positive or negative pressure.

In another embodiment, the device comprises at least two or more, three or more, four or more or five of: a solution module, lysis module, a lysis/solution module, harvesting module, homogenization module, lysis/homogenization module, filtration module and collection module for collecting subcellular components from a homogenized, filtered sample.

In one aspect, the collection module comprises a matrix for preferentially and reversibly retaining a desired subcellular components (e.g., such as proteins, nucleic acids, DNA or RNA, lipids, carbohydrates, organelles, and the like). However, alternatively or additionally, the collection module comprises a compartment or chamber for receiving a solution comprising a desired subcellular component which has passed through or come into contact with one or more, two or more, three or more, or four of the harvesting module, solution module, lysis module, homogenization module, and filtration module. In one aspect, the collection module collects a harvested, and homogenized sample. In another aspect, the collection module collects a harvested, solution-contacted, and homogenized sample. In still another aspect, the collection module collects a harvested, solution-contacted, homogenized and filtered sample, which may optionally be subjected to a chemical lysis step.

Subcellular components collected in the collection module may be removed from the collection module for further processing steps. Additionally, or alternatively, processing steps may occur in the collection module. For example, nucleic acids may be precipitated in the collection module using an appropriate alchohol and salt. More particularly, RNA can be pelleted in the collection module after precipitation using an RNA precipitating material (e.g., such as alcohol, LiCl, or a solution of guanidine and ethanol). Suitable RNA precipitating materials are known in the art. This precipitate can be collected via, for example, centrifugation.

In one embodiment, the collection module may be separated from one or more modules of the device (e.g., solution module, lysis module, harvesting module, homogenization module, filtration module). In one aspect, the solution module, homogenization module, and filtration module are provided in the form of a column that fits into the lumen defined by the walls of the device housing and the collection module is formed in the space between the column and the closed bottom end of the housing. Removing the column from the device provides access to the collection module. Alternatively, the collection module may be removed from the remainder of the device modules (e.g., by snapping off or twisting). In one aspect, the closed bottom end may comprise a cap or cover which may be removed to obtain collected material. A desired subcellular component (e.g., such as an RNA-containing elute) may be obtained from the collection module for further processing (e.g., such as alcohol precipitatation) or it may be obtained directly from the collection module for use in an assay without further processing.

The collection module may include molecules (e.g., in the form of a membrane, matrix, gel, particles, beads, filter, and the like) for specifically binding a desired subcellular component. For example, an RNA isolation membrane may be provided as part of the collection module to facilitate the collection of the RNA precipitate, washing of the collected precipitate (reduced wash volumes and centrifugation times) and re-suspension and elution of the target nucleic acid.

In certain aspects, the collection module may include a material that nucleic acids. In one aspect, the material reversibly binds RNA. Suitable nucleic acid-binding materials are known in the art and include, but are not limited to SiO₂-based materials or silicon carbide (see, e.g., U.S. Pat. Nos. 6,177,278 and 6,291,248). As an alternative to silicon carbide, silica materials such as glass particles, glass powder, silica particles, glass microfibers, diatomaceous earth, and mixtures of these compounds may be employed. In another aspect, the collection module comprises one or more polymeric membranes, examples of which include, but are not limited to, polysulfone, e.g., such as a BTS membrane (Pall Life Sciences), PVDF, nylon, nitrocellulose, PVP (poly(vinyl-pyrrolidone)), MMM filters (Pall Life Sciences, available from VWR, Pittsburg, Pa.) and composites thereof. In another aspect, the binding material comprises an asymmetric membrane with pores that gradually decrease in size from the upstream side to the downstream side. In one aspect, the membrane comprises pore from about 1 μm to 10 μm. Binding materials may be combined with chaotropic salts to isolate nucleic acids, such as RNA in the collection module. In one aspect, an RNA-binding material comprises a SiCw matrix. Exemplary carbohydrate-binding materials include, but are not limited to materials (e.g., filters, membranes, solid phases, etc) comprising lectins. Exemplary lipid-binding materials include hydroxyapatite-coated materials.

Examples of nucleic acid-binding materials additionally include, but are not limited to, various types of silica, including glass and diatomaceous earth. In some aspect, binding materials include binding moieties stably associated with a solid phase, such that DNA and/or RNA molecules will bind to the solid phase by virtue of this association. Nucleic acid-binding moieties include anion exchange groups such as diethylaminoethane (DEAE), cation exchange groups such as carboxylates, immobilized dyes that bind nucleic acids (e.g., methidium, ethidium, and ethidium homodimer), and hydrophobic interaction groups. Thus, examples of solid phase nucleic acid-binding materials also include silica particles, magnetic beads coated with silica, and resins coated with anion or cation exchange groups, hydrophobic interaction groups, dyes, and the like.

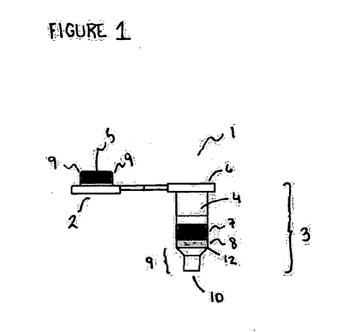

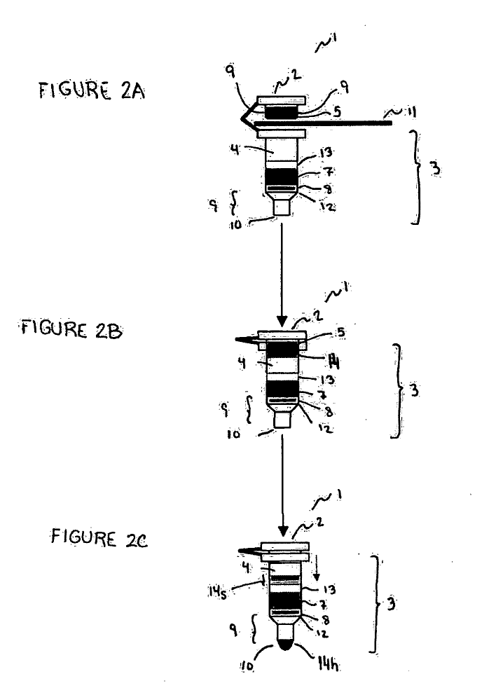

An exemplary device according to one embodiment of the invention is shown in FIG. 1. In this embodiment, device 1, comprises a cap 2 and a housing 3 comprising walls defining a lumen 4 comprising one or more modules of the device 1. Edges 9 of the cap 2, form edges of the harvesting module. Alternatively, or additionally, edges of the open end 6 of the housing 3, form edges of the harvesting module. The device 1 further comprises a solution medium 5 stably associated with or affixed to the cap 2, such that it does not fall off the cap 2 when the cap 2 is inverted to seal an open end 6 of the housing 3. When a sample 11 is brought in contact with the edges of the harvesting module (as shown in FIG. 2A, for example), it is also brought into contact with the solution medium which may optionally comprise a lysis solution contained therein. In one aspect, a core of sample exposed to the solution medium is ejected into the device for further processing. In another aspect, the solution medium comprises a lysis solution and a lysed sample is ejected into the device for further processing. The device shown in FIG. 1 additionally comprises a homogenization module 7, which is shown in FIG. 1 as being adjacent to a filtration module 8. In the embodiment shown in FIG. 1, a collection module 9 lies between the filtration module 8 and a closed bottom end 10 of the device. A frit 12 lies between the filtration module 8 and collection module 9 to maintain the homogenization module and filtration module in a relatively stable position within the device. A frit or retainer ring 13 may be placed on one or both sides of the homogenization module to provide for additional stability.

FIG. 1 shows a non-limiting embodiment of the invention. Numbers of modules and their order in the device may vary. Modules may be adjacent or separated by one or more chambers between modules (for example, defined by a space between an end of one module and the beginning of the next). Although a single solution module 5 is shown, a lysis module may be provided distal to the homogenization module (as used herein, proximal to distal is measured from the open end 6 to the closed bottom end 10 of the device housing 3). Alternatively or additionally, the solution module may comprise a lysis solution as discussed above. In another aspect, a lysis module may be placed distal to the sample but proximal to the homogenization module. In a further aspect, the homogenization module is impregnated with a lysis solution. A distinct lysis module for performing chemical lysis is an optional feature of the device. Multiple homogenization modules may be provided, which optionally may be separated by one or more filtration modules. As discussed above, the order, placement and number of modules may vary and is not a limiting feature of the invention.

In one embodiment, devices according to aspects of the invention are used to isolate RNA and more particularly, tcRNA. In one aspect, use of the device enables the collection of intact RNA. In another aspect, use of the device enables the collection of RNA greater than about 200 bp, though smaller RNA may be collected as well. In a further aspect, RNA greater than about 1000 bp or greater than about 5000 bp may be collected. The quality and/or quantity of RNA collected may be evaluated and optimized using methods well known in the art, such as obtaining an A260/A280 ratio, evaluating an electrophoresed sample, or by using Agilent Technologies® RNA 6000 Nano assay (part no. 5065-4476) on the Agilent Technologies® Bioanalyzer 2100 (part no. G2938B, Agilent Technologies®, Palo Alto, Calif.) as per manufacturer's instructions.

Methods for isolating subcellular components are also disclosed herein. In one aspect, a method according to the invention comprises providing a sample source (e.g., such as a plant), harvesting a sample (e.g., such as a core of leaf tissue) from the sample source and homogenizing a harvested sample to collect desired subcellular components (e.g., proteins, nucleic acids, such as DNA or RNA, lipids, subcellular organelles, membrane fractions, and the like). In another aspect, the sample is additionally contacted with a solution. In a further aspect, harvesting, solution-contacting and homogenization steps occur in a single device and without the need to transfer sample from one container to another. In another aspect, the method comprises the steps of providing a sample source, harvesting a sample from the sample source, contacting the sample source with a sample solution, optionally chemically lysing the harvested sample to produce an at least partially lysed sample, and homogenizing the sample to produce a homogenized sample, without transferring sample from one device or container to another, between at least two of the steps, or at least three of the steps. In certain cases, as discussed above, harvested sample may be stored in the device for some time prior to further steps, such as solution-contacting, homogenization and collection.

In still another aspect, the method further comprises the step of filtering or removing undesired subcellular components from a harvested, solution-contacted, homogenized sample (and optionally, chemically lysed sample) without transferring sample from one container to another between at least two of the steps, at least three of the steps, or at least four of the steps. In a further aspect, the method further comprises the step of collecting desired subcellular components from a harvested, solution-contacted, homogenized, optionally chemically lysed, filtered sample without transferring sample from one container to another between at least two of the steps, at least three of the steps, at least four of the steps, or at least five of the steps. In one aspect, the desired subcellular components comprise protein. In another aspect, the desired subcellular components comprise nucleic acids, such as DNA and/or RNA (e.g., tcRNA). In a further aspect, the desired subcellular components are obtained from plant tissue.

Although the steps are described as including harvesting, solution-contacting, homogenizing, filtering and collecting, steps may be duplicated, deleted and in some cases the ordering may be varied. For example, the solution-contacting step (and/or a chemical lysing step) may be repeated after the homogenization step or combined with the homogenization step. Similarly, filtration may be combined with homogenization or performed before and/or after homogenization. In certain cases, the device is used for harvesting and homogenizing a sample, while additional process steps occur outside the device. Additional steps performed using the device may also be included. For example, collection of desired subcellular components may follow a step of binding such components to an binding material and subsequent elution therefrom. In one aspect, a chemical lysis step is deleted, and the method relies on physical disruption of cells that occurs during homogenization. Other variations in steps are possible and these additional steps are encompassed within the scope of the invention. The one or more steps above may be performed using any of the devices as described above.

In one aspect, as shown in FIG. 2A, a sample source 11 (in this case a leaf tissue sample) is contacted to the edges 9 of a harvesting module and a sample core 14 is obtained from the sample source. In the aspect shown in FIG. 2A, the harvesting module comprises edges 9 of one or more of a cap 2 and open end 6 of the device housing 3, such that placing a sample source 11 between the cap 2 and the open end 6 of the device housing 3 and snapping the cap closed results in a core or disc of sample 14 being punched from the sample source 11. In one aspect, the device is pre-chilled to minimize degradation of subcellular components (e.g., such as RNA) while a sample is being harvested. In another aspect, neither the sample nor the sample source is weighed prior to or after contact with the harvesting module.

As shown in FIGS. 2A and 2B, in one aspect, this action brings the sample 11 in appropriate proximity to a solution medium 5 under suitable conditions such that the sample is sufficiently wetted for further processing steps. In one aspect, the solution medium 5 comprises a lysis solution and contact with the medium occurs until the sample is at least partially lysed (e.g., greater than 50% of cells in the sample comprise cell membranes that are at least partially damaged such that about 50% or greater of intracellular components are no longer retained within the cell). In one aspect, greater than about 60%, greater than about 70%, greater than about 80%, greater than about 90%, or about 100% of the sample cells are lysed (i.e., comprise cell membranes that are at least partially damaged such that about 50% or greater of intracellular components are no longer retained within the cell).

However, in another aspect, solution does not contact a sample until, after, or while homogenization occurs (e.g., after or during centrifugation or the application of pressure). In one aspect, harvested sample may be snap frozen to minimize nucleic acid degradation (such as RNA degradation) until homogenization occurs. In another aspect, solution is frozen with the sample (but not in contact with the sample) or applied at the time of homogenization. In still a further aspect, sample harvesting is performed and harvested sample is stored (with or without freezing and/or refrigeration) until processing may occur. In certain cases, where refrigeration/freezing is not used a sample may be subjected to desiccation (e.g., by applying a vacuum to the device). In one aspect, sample is stored under ambient environmental conditions (e.g., at room temperature or in the field). In such cases, it may be desirable to prevent solution-contact with sample, as discussed above and/or to include agents to preserve desired subcellular components (e.g., providing: sterile devices, DEPC or vanadyl-treated devices, or devices treated with other nuclease inhibitors, devices treated with protease inhibitors, or some combination thereof).

In some embodiments, samples are contacted with a chemical lysis solution. Examples of lysis solutions suitable for lysing various types of biological materials are found in Molecular Cloning by Sambrook, et al., 2nd edition, Cold Spring Harbor Laboratory Press, P. 7.3 et seq. (1989); Protocols and Applications Guide produced by Promega Corporation 3rd edition, p. 93 et seq. (1996); and by Chirgwin J. M. et al., 18 Biochemistry 5294(1979).

In one aspect, the lysis step includes exposure to one or more chaotropic salts, for example, where nucleic acids are desired subcellular components and proteins are not. The chaotrope used can be guanidine, ammonium isothiocyante, or guanidine hydrochloride. One skilled in the art will appreciate that other chaotropes can be used and remain within the scope of this invention. Typically, the concentration of the chaotrope ranges from about 0.5 M to about 8.0 M. In one aspect, the concentration of chaotrope comprises 5.5M guanidine HCl. Again, these concentrations can vary depending upon the sample matrix as well as other factors known to those skilled in the art. Chaotropic agents are used, for example, to denature proteins and to inhibit inter-molecular interactions, and importantly to inhibit the action of nucleases that can be present and may degrade the nucleic acid of interest. Monitoring nucleic acid integrity throughout the process can be performed by several methods, most commonly by electrophoretic methods and by PCR assays (RT-PCR, where RNA is the desired subcellular component). In one aspect, the lysis solution additionally comprises β-mercaptoethanol (e.g., such as a 1% solution of β-mercaptoethanol). In another aspect, the method does not include using phenol.

In one aspect, a stock solution of lysis buffer comprises 4 M Guanidine Thiocyanate (Sigma, St. Louis, Mo.), 25 mM Tris, pH 7 (Ambion, Austin, Tex.). To make a working solution, β-Mercaptoethanol is added to a concentration of 143 mM. In another aspect, e.g. such as for the isolation of plant RNA, the solution comprises 5.5M guanidine HCl, 50 mM Bis-Tris pH6.6, 10 mM EDTA and 1% β-Mercaptoethanol.

Centrifugation may be used to drive cells into contact with and through the homogenization module 7 thereby at least partially homogenizing the sample (see, FIGS. 2B and 2C) (i.e., greater than about 50%, greater than about 60%, greater than about 70%, greater than about 80%, greater than about 90%, or about 100% of cells comprise disrupted cell membranes). In certain aspects, centrifugation also drives solution-contacted cells 14s and through the homogenization module 7. The homogenization module 7 also may be impregnated with additional lysis solution to further lyse cells. In one aspect, the lysed sample is centrifuged through a homogenization module for about 3 to about 5 minutes at 16,000×g. In another aspect, the sample is centrifuged from 5 to 20 minutes at about 3,000 to 16,000×g. In another aspect of the invention, the homogenization step occurs less than about 2 minutes after contact between the harvested sample and solution medium, less than about 1 minute after contact, less than about 30 seconds after contact, or less than about 10 seconds after contact. Although generally about 10 μl of solution per mg of sample is used, in certain aspects, increased amounts of buffer may be used (e.g., about 2 times, about 5 times or about 10 times) to increase the yield of nucleic acids (e.g., RNA) obtained. In one aspect, about 100-1 ml, or about 100-600 ml of a homogenized sample solution is generated after passing a lysed sample through a homogenization module. Homogenized sample 14h may be collected in collection module 9.

In certain aspects, e.g., when the device comprises a housing having an open end, sealable by a cap (which may be removable), the homogenization module may be in sufficient proximity to the open end that pressure on the sample by the cap forces a sample being harvested against the homogenization module, at least partially homogenizing the sample. The sample may be further homogenized by centrifugation and/or the application of additional pressure. Chemical lysis also may be performed by contacting the sample with a lysis medium affixed to the cap and/or by providing lysis solution in the homogenization module and/or in a discrete lysis module distal to the homogenization module.

In one aspect, centrifugation further drives homogenized sample through a filtration module 8, which substantially removes undesired subcellular components from the homogenized sample. When RNA is being isolated, these components may include gDNA, proteins, carbohydrates as well as other cellular debris. In one aspect, DNA contamination of RNA isolated after passage through the filtration module 8 is around 1000 to 10,000 fold lower than samples isolated without the filter. The filtration module 8, may further homogenize the homogenized sample, which has passed through the homogenization module 7. Assays to detect contaminants include, but are not limited to, electrophoretic and spectrophotometric methods and functional assays such as PCR or reverse transcription. In one aspect, the device is modified to include additional homogenization material and/or filtration material (e.g., additional filter or membrane layers, and/or inclusion of material with different particle retention sizes and porosity) to minimize contaminants that are unique to a particular sample type.

As discussed above, lysis solution may be provided in the solution medium 5 and/or in the homogenization module 7 and/or as part of a separate lysis module proximal or distal to the homogenization module 7. In certain embodiments, however, lysis solution is not used.

In a one embodiment of a method according to the invention, passage through the homogenization module and/or filtration module may be effected, for example, by mechanical action on the sample side, e.g., increased pressure or gravity, such as may be generated by centrifugation. Negative pressure may also be applied at a portion of the device distal to the sample being processed, e.g., distal to the homogenization module 7 and/or filtration module 8. In certain cases physical pressure, such as pressure applied against the cap, forces a sample core into the homogenization module and/or filtration module. A combination of the above also may be used.

When the sample comprises plant cells, the flow-through may appear clear or slightly yellow. A green flow-through from photosynthetic tissue may indicate incomplete homogenization or filter clogging. In such cases, sample may be passed through the same or a new column one or more times. Additionally, when RNA is being collected DNAse (DNase I or II) may be added before, during, and/or after the filtration step, to complete removal of any residual gDNA, that has passed through the filtration module. DNAse may be obtained from commercial sources and is preferably, provided in an RNase-depleted form. However, in one aspect, no DNAse is added. Similarly, when DNA is being collected, RNAses may be included. Proteases may be included in samples where proteins are undesired subcellular components. Enzymes specific for certain types of molecules that are undesired also may be added. For example, restriction enzymes that recognize particular undesired sequences may be added to remove those sequences.

Additionally or alternatively, inhibitors of any of the above enzymes may be added to promote collection of particular types of subcellular components. For example, protease inhibitors may be added where proteins are being collected. DNAse inhibitors may be added where DNA is being collected. RNAse inhibitors may be added where RNA is being collected.

In one aspect, RNA from a filtered sample is collected. An organic solvent may be added to the sample (e.g., after removing a homogenization module 7 and/or filtration module 8 from the housing 3 of the device 1). For example, a low molecular weight alcohol such as ethanol, methanol or isopropanol in the range of about 50-250% by volume may be used. RNA may be precipitated, e.g., by centrifugation at 16,000 g for at least three minutes.

In another aspect, a filtered sample is contacted with an RNA-binding material such as silicon carbide, e.g., in the form of a silicon carbide whisker (“SiCw”). In one aspect, the filtered solution is contacted to a 3.9 m2/g SiCw (as measured by surface Nitrogen absorption). Methods according to certain aspects of the invention require very small solution volumes. In one aspect, about 10 μl to about 50 μl of buffer or water may be used to elute RNA from the RNA-binding material. Preferably, the water is sterile and/or nuclease- and/or RNAse-free. The RNA-binding material may be washed one or more times by contacting the binding material with a wash solution and centrifuging (e.g., at about 16,000×g for about two minutes) or otherwise exerting positive or negative pressure on a solution passing through the RNA-binding material.

In one aspect, one or more of the following wash buffers may be used:

Wash Buffer #1:

from about 0.2 to about 2 M, e.g., 1 M Guanidine Thiocyanate (Sigma, St. Louis, Mo.) 25 mM Tris, pH from about 6 to about 9, e.g., 7 (Ambion, Austin, Tex.)
from about 5 to about 25% ethanol, e.g., 10% ethanol (Sigma, St. Louis, Mo.)
   Wash Buffer #2:
Twenty-five mM Tris, pH from about 6 to about 9, e.g., 7 (Ambion, Austin, Tex.) from about 40 to about 90% ethanol, e.g., 70% ethanol (Sigma, St. Louis, Mo.)
   Wash Buffer #3:

Five to 250 mM Tris, pH from about 6 to about 9, from about 40 to about 90% ethanol.

Suitable elution buffers include, but are not limited to: 10 mM EDTA, 10 mM sodium citrate, pH ranging from 6 to 9 as well as free-nuclease water.

In one aspect, a method according to the invention provides RNA yields absorbance ratios at 260/280 and 260/230 1.8 or above, indicating that the samples are free of protein and polysaccharide contamination, respectively. Absorbance at 260 nm and 280 nm may be measured on an Agilent Technologies® 8453 UV/VIS spectrophotometer to confirm the presence of eluted RNA. For a detailed protocol regarding spectrophotometry of RNA, see “Molecular Cloning. A Laboratory Manual”, Volume 3, Section A8.20 (Sambrook and Russel, 2001). RNA may also be assayed by performing an RNA 6000 Nano Assay (Agilent Technologies®, Palo Alto, Calif., part no. 5065-4476) on the Bioanalyzer 2100 (Agilent Technologies®, Palo Alto, Calif., part no. G2938B), as per Manufacturer's instructions.

For plant cell or tissue samples, high quality total RNA will generally exhibit clear, sharp ribosomal RNA bands. The number of RNA bands can vary between species and tissue types. For example, photosynthetic tissue, such as leaf tissue, contains several smaller ribosomal RNAs from the chloroplast in addition to the cytosolic 25S and 18S rRNAs bands. Non-photosynthetic tissue, such as seed or root tissue, does not contain these extra plastid rRNA bands. Quality plant total RNA will generally have sharp, distinct rRNA peaks. High baseline and indistinct peaks may be indicative of RNA degradation. Messenger RNA from plants typically accounts for only 0.1% of the total RNA and is usually not seen on a gel.

The devices and methods of certain aspects of the invention are particularly useful for working in the field as a sample, such as a core of leaf tissue, may be obtained directly from a plant without removing the plant from its environment (e.g., such as a field in which the plant is being cultivated). In certain aspects, as discussed above, harvesting modules are used remotely from the device, and harvested sample is stably associated with the harvesting module (e.g., remains in proximity to the harvesting module) until contact with a device according to the invention. The devices and methods also are particularly useful in high throughput assays. In certain aspects, a plurality of devices are provided in a holder or molded as a unit for receiving a plurality of removable harvesting modules. The dimensions and configurations of the device may also be scaled as appropriate to use the device in preparative assays.

In one aspect, isolated RNA is obtained using devices and methods according to the invention which can be used in any method that requires RNA, including, but not limited to RT-PCR, real time PCR, chemical array analysis, and the like. In one aspect, the isolated RNA obtained may be used without any further purification steps. However, in other aspects, RNA is collected and further processed and/or isolated.

In one aspect, isolated nucleic acids, such as RNA, may be labeled to produce labeled nucleic acid molecules.

In another aspect, isolated RNA is reverse transcribed to produce cDNA, which may be further amplified, sequenced, cloned, and/or used in any other assay in which cDNA is typically used.

Isolated nucleic acids, such as RNA, may be used as probe or target molecules. Likewise, complementary copies of isolated RNA (cDNA or cRNA) may be used as probe or target molecules.

In one aspect, isolated RNA or a complementary copy thereof is contacted with a chemical array and binding of the isolated RNA or the copies thereof is assessed, e.g., to evaluate gene expression in cells from a harvested sample.

In one embodiment, the invention further provides kits. In one aspect, a kit according to the invention provides two or more of: a solution module, lysis module, harvesting module, homogenization module, filtration module, and collection module. In another aspect, the kit provides three or more of a solution module, lysis module, harvesting module, homogenization module, filtration module, and collection module. In a further aspect, the kit provides four or more of a solution module, lysis module, harvesting module, homogenization module, filtration module, and collection module. In still another aspect, the kit provides a solution module, lysis module, harvesting module, homogenization module, filtration module, and collection module. In one aspect the kit comprises any one or more of the modules or devices described above. In another aspect, the kit comprises one or more suitable reagents for performing methods according to the invention, e.g., such as an organic solvent, wash buffer, proteases, DNAse, RNAse, DEPC, vanadyl compounds, other RNAse inhibitors, DNAse inhibitors, protease inhibitors, a tissue stabilizer (e.g., such as ammonium sulfate, RNAlater, etc), and the like. Additional reagents such as typically used in assays relying on desired subcellular components may be include. For example, nucleic acid collection kits may include PCR reagents, array(s), hybridization buffers, control nucleic acids, and the like. Protein collection kits may include antibodies, arrays, etc. Instructions for a practitioner to practice the invention may also included.

While this invention has been particularly shown and described with references to specific embodiments, it will be understood by those skilled in the art that various changes in form and details may be made therein without departing from the spirit and scope of the invention as defined by the appended claims.

References, patents, and patent applications cited herein are incorporated by reference in their entireties herein.

What is claimed is:

1. A device for collecting a subcellular component of a biological sample, comprising:
a solution module comprising a solution medium for contacting a biological sample;
and a collection module for collecting subcellular components from the biological sample.

2. The device of claim 1, wherein the solution medium comprises an absorbent material for retaining solution.

3. The device of claim 1, wherein the solution medium comprises a barrier separating solution in the solution medium from the collection module.

4. The device of claim 3, wherein the barrier comprise a removable seal.

5. The device of claim 1, wherein the solution is added to the solution medium after a sample is placed in the device.

6. The device of claim 1, wherein the solution comprises a chemical lysis agent.

7. The device of claim 1, further comprising one or more modules selected from the group consisting of:
a harvesting module for obtaining a biological sample from a sample source;
a lysis module for chemically lysing a biological sample;
a homogenization module for homogenizing a biological sample; and
a filtration module for removing undesired subcellular components from a biological sample.

8. The device of claim 7, wherein the device comprises two or more of the harvesting module, lysis module, homogenization module, and filtration module.

9. The device of claim 7, wherein the device comprises three or more of the harvesting module, lysis module, homogenization module, and filtration module.

10. The device of claim 7, wherein the device comprise a lysis module, homogenization module, and filtration module.

11. The device of claim 7, wherein the solution module and/or the homogenization module comprises a lysis solution.

12. The device of claim 7 wherein the device comprises the filtration module, and the filt6ration module comprises a material for removing insoluble cell debris from a biological sample.

13. The device of claim 7, wherein the device comprises the filtration module, and the filtration module comprises a material for removing protein from a biological sample.

14. The device of claim 7, wherein the device comprises the filtration module, and the filtration module comprises a material for removing nucleic acids from a biological sample.

15. The device of claim 7, wherein the device comprises the filtration module, and the filtration module comprises a material for removing genomic DNA from a biological sample.

16. The device of claim 7, wherein the device comprises the homogenization module and the homogenization module forms a barrier to a non-homogenized sample until a force is applied to the sample.

17. The device of claim 16, wherein the force is centrifugal force.

18. The device of claim 16, wherein the force comprises pressure.

19. The device of claim 7, wherein the device comprises the homogenization module and the homogenization module comprises at least one material suitable for removing cellular debris from the sample solution.

20. The device of claim 7, wherein device comprises the filtration module and the filtration module comprises a fiber material having a particle retention ranging from about 0.1 μm to about 10 μm.

21. The device of claim 7, wherein the device comprises the harvesting module and the harvesting module is in sufficient proximity to the solution module, for solution to contact a sample as it is harvested by the harvesting module from a sample source.

22. The device of claim 7, wherein the device comprises the harvesting module, and solution in the solution module is prevented from contacting a sample harvested by the harvesting module.

23. The device of claim 22, wherein the solution in the solution module is contacted with harvested sample prior to collection in the collection module.

24. The device of claim 7, wherein the harvesting module comprises edges for coring a sample from a sample source.

25. The device of claim 1, wherein the device further comprises a binding material for binding the subcellular component.

26. The device of claim 23, wherein the binding material is selected from the group consisting of: silicon carbide, BTS, PVDF, nylon, nitrocellulose, polysulfone, MMM, PVP, and composites thereof.

27. The device of claim 1, wherein the device comprises:
a housing with walls defining a lumen,
an open end, and
a closed bottom end, and the collection module is within the lumen of the housing.

28. The device of claim 27, wherein the lumen further contains at least one of:
a lysis module for chemically lysing a sample;
a homogenization module for homogenizing a sample; and
a filtration module for removing subcellular components from a sample.

29. The device of claim 27, wherein the device further comprises a cap for covering the open end, the cap comprising edges for coring a sample from a sample source which is placed between the edges and the open end.

30. The device of claim 29, wherein the solution medium is stably associated with the cap.

31. The device of claim 30, wherein solution medium comes into contact with a sample when it is place between the edges of the cap and the open end.

32. The device of claim 30, wherein the solution module comprises a removable or penetrable barrier that isolates solution in the solution module from the sample when it is placed between the edges of the cap and the open end until the barrier is removed or penetrated.

33. The device of claim 29, wherein the device comprises the homogenization module, and the homogenization module is sufficiently proximal to the open end, that covering the open end with the cap while a sample is being cored brings the sample into contact with the homogenization module.

34. The device of claim 27, wherein the device comprises the filtration module and the filtration module is capable of removing subcellular components selected from the group consisting of proteins, lipids, carbohydrates, DNA, RNA and combinations thereof from a sample.

35. The device of claim 27, wherein the device comprises a column insertable into the lumen of the housing and wherein the column comprises one or more of:
the lysis module;
the homogenization module for homogenizing a sample and;
the filtration module for removing subcellular components from a sample.

36. A kit comprising a device of claim 1, and a reagent for facilitating isolation, stabilization, or analysis of a subcellular component.

37. A method for collecting a subcellular component from a biological sample, comprising contacting a biological sample with a solution provided in a device of claim 16, homogenizing the sample, and collecting a subcellular component from the homogenized sample.

38. The method of claim 37, wherein the biological sample is cored from a sample source prior to contacting the sample with solution.

39. The method of claim 37, wherein the sample is contacted with solution prior to homogenizing.

40. The method of claim 37, wherein the biological sample is contacted with solution after or during homogenization.

41. The method of claim 37, further comprising the step of removing undesired subcellular components from the homogenized sample.

42. The method of claim 37, wherein the collected subcellular component is selected from the group consisting of protein, nucleic acid, DNA, RNA, lipids, organelles, nucleic, membrane fractions, and combinations thereof.

43. The method of claim 37, wherein the undesired subcellular component is selected from the group consisting of cell membranes, protein, RNA, DNA, lipids, organelles, membrane fractions and combinations thereof.

44. The method of claim 37, wherein the collected subcellular component comprises RNA.

45. The method of claim 44, wherein the biological sample comprises plant cells.

46. The method of claim 38, wherein the cored sample is separated from solution in the solution medium by a barrier, and the barrier is removed or penetrated prior to contacting the cored sample with the solution.

47. The method of claim 38, further comprising contacting sample with a chemical lysis agent.

48. The method of claim 37, wherein homogenization occurs by subjecting the sample to a force, which forces the sample through the homogenization module.

49. The method of claim 48, wherein the force comprises centrifugal force.

50. The method of claim 48, wherein the force comprises pressure.

51. The method of claim 44, further comprising contacting RNA-containing solution to an RNA-binding material and eluting RNA from the RNA-binding material.

52. The method of claim 37, further comprising contacting the collected subcellular component with a chemical array.

53. A method comprising:
providing a device comprising a harvesting module comprising edges for coring a sample from a sample source and a homogenizing module for disrupting cells in a harvested sample;
placing a sample source in proximity to the edges of the harvesting module;
coring a sample from the sample source; and
bringing the cored sample in proximity to the homogenizing module and homogenizing the cored sample.

54. The method of claim 53, wherein the harvesting module may be separated from the homogenizing module and the sample is cored from the sample source while the harvesting module is separated from the homogenizing module.

55. The method of claim 53, wherein the sample is contacted with a solution prior to or during homogenization.

56. A system comprising
a plurality of lumens, each lumen comprising a collecting module for collecting a subcellular component, and a homogenization module for disrupting cells from a sample to release the subcellular component into the collecting module; and
a plurality of harvesting modules, wherein each harvesting module is capable of coring a sample from a sample source and releasing sample into a lumen when placed in proximity to the lumen.

57. The system of claim 56, wherein sample is released into the lumen when a force is applied to the harvesting module.

58. The system of claim 56, wherein the force comprises pressure.

59. The system of claim 56, wherein the force comprises centrifugal force.

60. The system of claim 56, wherein the homogenization module is removable from the lumen.

61. The system of claim 56, wherein the harvesting module is removable from the system and may be used to harvest sample remotely from the system.

62. A harvesting module comprising edges for coring a sample in proximity to a surface with which a sample may be stably associated.

63. The harvesting module of claim 62 wherein the sample is stably associated with the surface at room temperature or greater.

64. The harvesting module of claim 62, wherein the sample is stably associated with the surface when the sample is refrigerated.

65. The harvesting module of claim 62, wherein the sample remains in proximity to the surface in the absence of force exerted on the harvesting module.

66. The harvesting module of claim 63, wherein the force comprises pressure.

67. The harvesting module of claim 63, wherein the force comprises centrifugal force.

68. A kit comprising a plurality of harvesting modules of claim 60.
